(19) United States
(12) Patent Application Publication
(10) Pub. No.: US 2003/0039595 A1
(43) Pub. Date: Feb. 27, 2003

(54) Modular exhaust treatment system

(76) Inventor: C. Joseph Geise, Indianapolis, IN (US)

Correspondence Address: Richard A. Rezek, Barnes & Thornburg, 11 South Meridian Street, Indianapolis, IN, 46204, US

(21) Appl. No.: 09/939,242

(22) Filed: Aug. 24, 2001

(51) Int. Cl. B01D 53/34; F23J 11/00; B32B 27/02

(52) U.S. Cl. 422/168

(57) ABSTRACT

Modular emissions filters and modular muffler turning elements are stacked on one another or arranged in end-to-end relation to one another to form an exhaust processor without using a common outer shell. The modules are interchangeable and a kit comprising a wide variety of types of exhaust component modules is used at an exhaust processor assembly site to facilitate assembly of customized exhaust processors.

### BACKGROUND AND SUMMARY OF THE INVENTION

This disclosure relates to exhaust processors, and particularly to exhaust processors for use in vehicle exhaust systems. More particularly, this disclosure relates to exhaust processors configured to filter contaminants included in vehicle combustion product and to attenuate noise associated with vehicle combustion product.

Unwanted contaminant material is often removed from a stream of combustion product discharged from an engine by passing that combustion product stream through a filter. Many different types of filters are used to remove pollutants and other unwanted contaminant material from exhaust gas.

One such filter is a “catalytic converter” having a porous metallic or ceramic substrate carrying an emissions catalyst. A “reducing” emissions catalyst is used to reduce unwanted oxides, such as oxides of nitrogen, appearing in the combustion product, into harmless gases, such as oxygen and nitrogen. An “oxidizing” emissions catalyst is used to complete the oxidation of unwanted gases, such as carbon monoxide and unburned hydrocarbons, appearing in the combustion process as a result of incomplete combustion, into harmless gasses, such as carbon dioxide and water vapor.

Another such filter is a diesel particulate trap comprising a monolithic cellular structure formed to include a large number of thin-walled passages extending longitudinally between an inlet end face and an outlet end face of the cellular structure. Each of the thin-walled passages is opened at one end and closed at an opposite end to force the exhaust gas to pass through the thin walls defining the thin-walled passages, and these walls function as a filter to separate particulate matter from the exhaust gas stream passing through the trap.

Noise in a vehicle exhaust system arises, in part, from acoustic pressure waves that are generated by the sudden release of exhaust gases from the individual cylinders of the vehicle engine. These acoustic pressure waves travel from the exhaust manifold through the exhaust pipe to a muffler. To dampen these acoustic waves to reduce unwanted sound emitted by the vehicle, various tuning systems including, for example, tube and baffle structures and resonance chambers are provided in the muffler.

According to the present disclosure, a modular exhaust treatment system includes separate modular exhaust components that are coupled to one another in series in end-to-end relation to one another to form a sealed exhaust processor. An annular weldment seal is applied at a junction between each pair of adjacent modular exhaust components to establish a sealed exhaust processor.

In illustrative embodiments, the modular exhaust treatment system comprises an exhaust processor kit. That kit has component parts capable of being assembled at an exhaust processor assembly site to provide an exhaust processor assembly configured to be mounted in a vehicle exhaust system to treat combustion product flowing therethrough.

Various inventories of modular exhaust components are provided in the kit and available to an exhaust treatment system designer to enable that designer to pick and choose selected modular exhaust components among the inventoried modular components. The designer may arrange the interchangeable modular exhaust components in any quantity or order to produce a customized exhaust processor assembly to satisfy the needs of a customer for a particular vehicle made by that customer.

In one illustrative exhaust processor kit, a contaminant-filter inventory comprises several different modular contaminant filters, a noise-filter inventory comprises several different modular noise filters, and an exhaust flow-diffuser inventory comprises several different modular exhaust flow diffusers. It is also within the scope of this disclosure to provide an assortment of modular tuning-volume containers configured to mate with an adjacent modular noise filter to add “tuning” volume to the modular noise filter so as to enhance the ability of a standard-sized modular noise filter to attenuate noises not normally attenuated by that standard-sized modular noise filter alone.

In one illustrative embodiment, an exhaust processor assembly comprises in series a modular exhaust flow diffuser, a first modular contaminant filter designed to filter, e.g., hydrocarbons, a second modular contaminant filter designed to filter, e.g., oxides of nitrogen, a modular tuning-volume container, and a modular noise filter. The modular exhaust flow diffuser is configured to interrupt or otherwise alter the flow of combustion product passing therethrough to substantially uniformly distribute the flow of combustion product across the inlet face of a catalyzed substrate included in the first modular contaminant filter. An exhaust inlet module is coupled to an upstream end of the modular exhaust flow diffuser and an exhaust outlet module is coupled to a downstream end of the modular noise filter. The modular tuning-volume container is interposed between the second modular contaminant filter and the modular noise filter. In a presently preferred embodiment, the exhaust inlet module is modified to include the modular exhaust flow diffuser.

Additional features of the present disclosure will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is a diagrammatic view of an exhaust processor assembly site and a modular exhaust processor kit for use at the assembly site and showing inventories of various modular exhaust flow diffusers (D), contaminant filters (CF), noise filters (NF), and tuning-volume containers (T-VC) from which a designer can select modules to deploy in various module positions (MP) to create a customized exhaust processor assembly comprising a series of modular exhaust components that can be coupled at an upstream end to an engine and at a downstream end to an exhaust pipe (e.g., tail pipe) to treat combustion product discharged by the engine in a manner defined by the selection and arrangement of the interchangeable modular exhaust components;

FIG. 2 is a diagrammatic view showing a monolithic exhaust inlet module including a cone-shaped exhaust flow expander and a downstream exhaust flow diffuser;

FIG. 3 is a sectional view of a catalyzed metallic substrate and a sleeve therefore wherein an outlet end of the sleeve has been deformed to produce a male processor end configured to mate with a female processor end formed in an adjacent downstream modular exhaust component;

FIG. 4 is a sectional view of a catalyzed ceramic substrate and a mat mount in a substrate housing wherein an outlet end of the housing has been deformed to produce a male processor end configured to mate with a female processor end formed in an adjacent downstream modular exhaust component;

FIGS. 5-10 show diagrammatic exhaust processor assemblies produced using various combinations of interchangeable modular exhaust components included in the exhaust processor kit shown in FIG. 1;

FIG. 5 shows an assembly comprising in series an exhaust inlet module, a modular exhaust flow diffuser, a first type of modular contaminant filter, a second type of modular contaminant filter, a first type of noise filter, and an outlet exhaust module;

FIG. 6 shows an assembly comprising in series an exhaust inlet module, a modular exhaust flow diffuser, a second type of modular contaminant filter, a third type of modular contaminant filter, a second type of modular noise filter, and an outlet exhaust filter;

FIG. 7 shows an assembly comprising in series an exhaust inlet module, a modular exhaust flow diffuser, a modular contaminant filter, a modular noise filter, and an exhaust outlet module;

FIG. 8 shows an assembly comprising in series an exhaust inlet module, a modular noise filter, a modular exhaust flow diffuser, a modular contaminant filter, and an exhaust outlet module;

FIG. 9 shows an assembly comprising in series an exhaust inlet module, a modular exhaust flow diffuser, a modular contaminant filter, and an exhaust outlet module;

FIG. 10 shows an assembly comprising in series an exhaust inlet module, a modular exhaust flow diffuser, a modular contaminant filter, a modular tuning-volume container, a modular noise filter, and an exhaust outlet module;

FIG. 11 shows a side elevation view of an exhaust processor assembly comprising a series of interchangeable modular exhaust components in accordance with the present disclosure, with portions broken away, showing a male end on the downstream end of each module (other than the exhaust outlet module) and a female end on the upstream end of each module (other than the exhaust inlet module) and showing an interference fit between mating male and female ends of adjacent modules prior to application of an annular weldment seal to a junction between each pair of adjacent modules;

FIGS. 12a-12c show a sequence of coupling portions of an upstream exhaust component module to an adjacent downstream exhaust component module;

FIG. 12a shows a portion of a male end before it is mated with a portion of a matching female end;

FIG. 12b shows the portion of the male end mated with the portion of a matching female end to establish an interference fit therebetween;

FIG. 12c shows a weldment seal applied to a junction between the adjacent exhaust component modules to provide an annular sealed connection at the junction to unite and retain the pair of adjacent modules in fixed relation to one another;

FIG. 13 shows an alternative module connector comprising a female end formed on an upstream module, a male end formed on a mating downstream module, and an annular weldment seal;

FIG. 14 shows another modular connector;

FIG. 15 shows yet another modular connector; and

FIG. 16 shows still another modular connector.

### DETAILED DESCRIPTION OF THE DRAWINGS

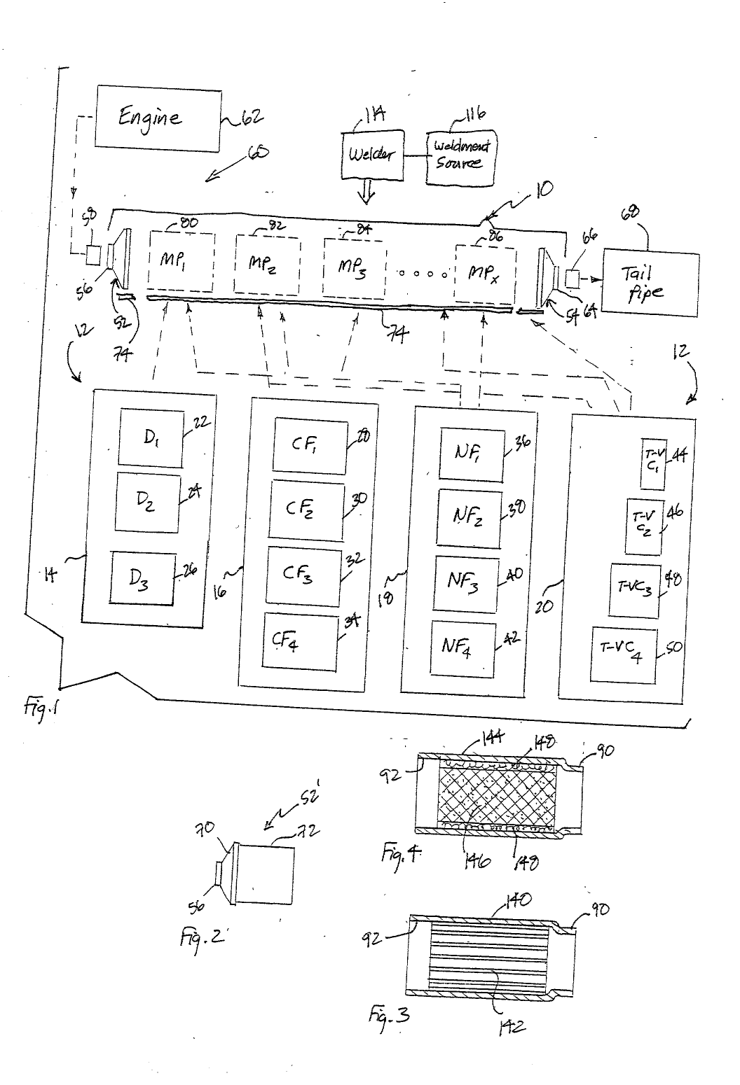

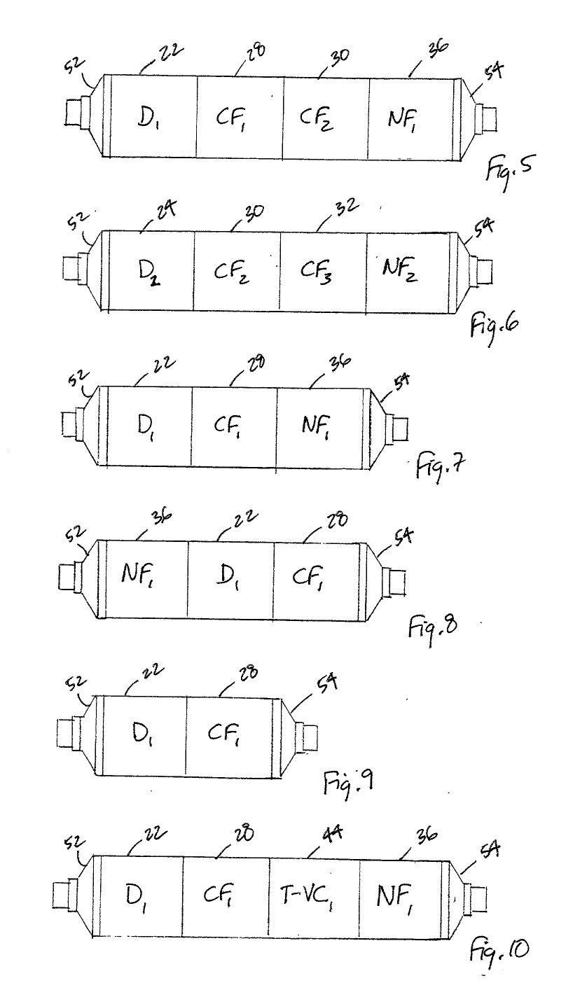

Interchangeable modular exhaust components are coupled to one another in series in stacked or end-to-end relation to one another in an order selected by a designer to produce a customized exhaust processor assembly. An exhaust processor assembly kit is shown diagrammatically in FIG. 1 and an illustrative exhaust processor assembly made of interchangeable modular exhaust components using the kit is shown in FIG. 11. Various illustrative combinations of interchangeable modular exhaust components arranged to form several customized exhaust processor assemblies are shown in FIGS. 5-10.

An exhaust processor assembly site 10 and a collection of interchangeable modular exhaust components 12 are shown diagrammatically in FIG. 1. In an illustrative embodiment, component collection 12 includes an exhaust flow-diffuser inventory 14, a contaminant-filter inventory 16, a noise-filter inventory 18, and a tuning-volume container inventory 20. It is within the scope of this disclosure to provide other exhaust component inventories including, for example, diesel particulate trap regenerators in component collection 12.

Exhaust flow-diffuser inventory 14 includes a plurality of types of interchangeable modular exhaust flow diffusers 22, 24, 26. An exhaust flow diffuser is configured to interrupt or otherwise alter the flow of combustion product passing therethrough to substantially uniformly distribute the flow of combustion product across an inlet face of a catalyzed substrate or diesel particulate trap included in an adjacent downstream contaminant filter. Such uniform inlet distribution functions to load the substrate or trap substantially evenly to enhance combustion product treatment efficiency of the substrate or trap. It is within the scope of this disclosure to include any quantity, style, type, or configuration of modular exhaust flow diffuser in exhaust flow-diffuser inventory 14.

Contaminant-filter inventory 16 includes a plurality of types of interchangeable modular contaminant filters 28, 30, 32, 34. A contaminant filter includes a catalyzed substrate or a diesel particulate trap. In the case of a trap, it is within the scope of this disclosure to include a trap regenerator in an interior region of the modular contaminant filter along with the diesel particulate trap. A trap regenerator includes a burner that is activated using a burner control system to begin a regeneration cycle to oxidize or otherwise incinerate particulate matter collected in the trap during normal operation of a diesel engine coupled to the trap. It is within the scope of this disclosure to include any quantity, style, type, or configuration of modular contaminant filter in contaminant-filter inventory 16. It is also within the scope of this disclosure to provide a burner in a separate module.

Noise-filter inventory 18 includes a plurality of types of interchangeable modular noise filters 36, 38, 40, 42. A noise filter includes one or more tubes, baffles, exhaust flow turn-around chambers, or resonance chambers arranged to attenuate selected noise frequencies associated with the stream of combustion product passing therethrough. It is within the scope of this disclosure to include any quantity, style, type, or configuration of modular noise filter in noise-filter inventory 18.

Tuning-volume container inventory 20 includes a plurality of “sizes” of interchangeable modular tuning-volume containers 44, 46, 48, 50 wherein each size is formed to include a certain tuning volume or expansion chamber. The tuning volume of container 44 is small, the tuning volume of container 46 is greater than that of container 44, the tuning volume of container 48 is greater than that of containers 44 and 46, and the tuning volume of container 50 is greater than that of containers 44, 46, and 48. Any one of the modular tuning-volume containers is configured to mate with an adjacent modular noise filter to add “tuning” volume (i.e., an expansion chamber) to the modular noise filter. This enhances the ability of a standard-sized modular noise filter to attenuate selected noise frequencies associated with a moving stream of combustion product that are not normally attenuated by the standard-sized modular noise filter acting alone (due, for example, to a small tuning volume associated with the standard-sized modular noise filter). As a result, by pairing a standard-sized modular noise filter with an adjacent modular tuning-volume container (to place the filter and container in acoustic communication with one another), it is possible to extend or otherwise alter the noise frequency attenuation range of the standard-sized modular noise filter simply by selecting a modular tuning-volume container having a proper volume to “add” tuning volume to the standard-sized modular noise filter.

Exhaust inlet modules 52 and exhaust outlet modules 54 are also available to the exhaust processor designer as suggested in FIG. 1. Exhaust inlet module 52 has an upstream inlet end 56 adapted to be coupled to a combustion product source pipe 58 that is mounted in a vehicle exhaust system 60 to conduct combustion product discharged by a vehicle engine 62. Exhaust outlet module 54 has a downstream outlet end 64 adapted to be coupled to a combustion product discharge pipe 66 that is coupled either to another downstream exhaust system device (not shown) or to a tail pipe 68.

In one embodiment shown in FIG. 1, exhaust inlet module 52 comprises a cone-shaped exhaust flow expander with interior walls that diverge from left to right in the direction that combustion product flows through vehicle exhaust system 60. In another embodiment shown in FIG. 2, exhaust inlet module 52′ is a monolithic unit comprising an upstream exhaust flow expander 70 and a downstream exhaust flow diffuser 72 appended to exhaust flow expander 70. Thus, monolithic exhaust inlet module 52′ carries its own “on-board” exhaust flow diffuser and is adapted to be coupled to an adjacent downstream modular contaminant filter selected from contaminant-filter inventory 16.

An exhaust processor can be defined at exhaust processor assembly site 10 using a kit comprising component collection 12. A module support fixture 74 is configured to support exhaust inlet module 52, exhaust outlet module 54, and any selected number of modules taken from component collection 12 in an order chose by the processor designer. Various module positions (MP₁, MP₂, MP₃, . . . and MPₓ) on module support fixture 74 that are available to receive modules from component collection 12 are represented by phantom boxes 80, 82, 84, and 86 shown diagrammatically in FIG. 1 to lie above modular support fixture 74. It is within the scope of this disclosure to use any suitable component fixturing system to support the modules selected and ordered by the processor designer so that an annular weldment seal also included in the kit can later be applied to a junction between each pair of adjacent modules.

To construct an exhaust processor at exhaust processor assembly site, the processor designer places one of the modules taken from component collection 12 in the first module position 80, a second of the modules taken from component collection 12 in the second module position 82, and so on . . . until all of the modules to be included in the exhaust processor are arranged in series in stacked or end-to-end relation to one another on modular support fixture 74. The modules taken from component collection 12 will cooperate to form a module conduit having an upstream inlet end coupled to exhaust inlet module 52 and a downstream outlet end coupled to exhaust outlet module 54. Thus, inlet and outlet exhaust modules 52, 54 serve as “bookends” to the ordered series of modules established on modular support fixture 74 by the processor designer.

Customization of an exhaust processor to meet the filtering and silencing needs of a customer is made simple owing, in part, to the interchangeable and modular character of the wide selection of exhaust components in inventories 14, 16, 18, 20 in component collection 12. By selecting the type and order of each modular exhaust component that is used to form the modular conduit interconnecting exhaust inlet module 52 and exhaust outlet module 54, a processor designer can build an exhaust processor custom-matched to most any vehicle engine system developed by a vehicle manufacturer.

A module connector is used to couple an upstream exhaust component module to an adjacent downstream exhaust component module. This module connector comprises mating connector portions and a weldment seal applied to adjacent modules at a junction therebetween established by the mating connector portions of the adjacent modules.

In one illustrative embodiment, a male connector portion 90 is formed on an outlet end of each module and a matched female connector portion 92 is formed on the inlet end of each module as suggested, for example, in FIGS. 3, 4, and 11. Each female connector portion 92 is sized to receive a male connector portion 90 “snugly” therein to align pairs of adjacent modules in coupled relation. It is within the scope of this disclosure to vary the “degree” of the snug interference fit established between mating male and female connector portions 90, 92 of adjacent modules and the magnitude of pushing force required to insert the male connector portion 90 of an upstream module into the female connector portion 92 of an adjacent downstream module.

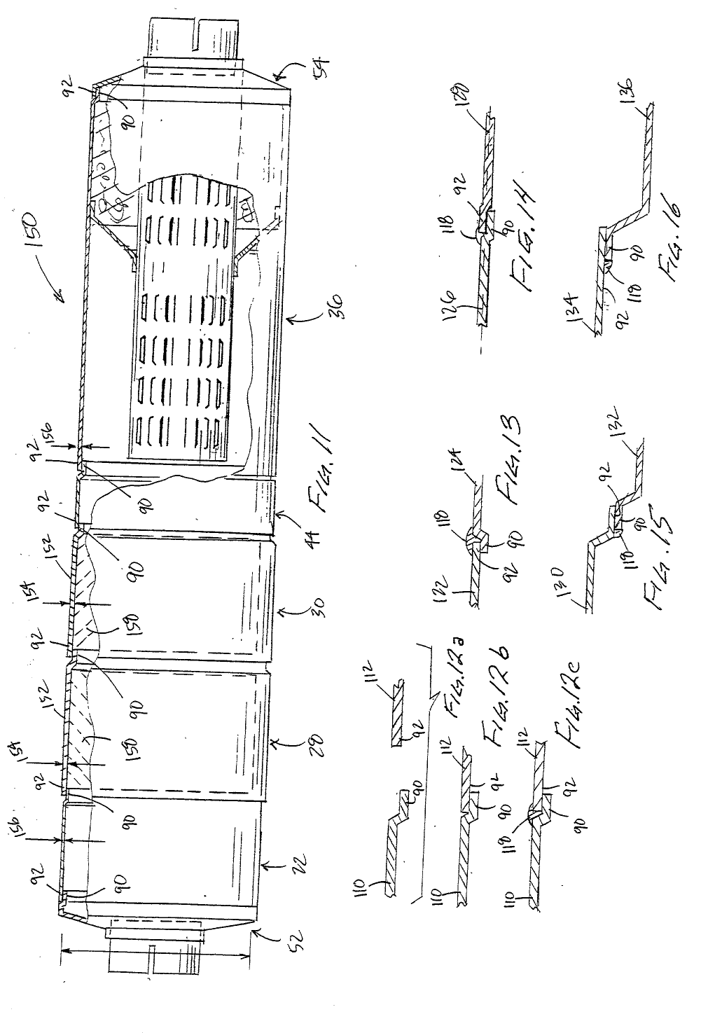

As suggested in FIGS. 12a, b, and c, the first step in coupling an upstream exhaust processor module 110 to an adjacent downstream exhaust processor module 112 is to position the male connector portion 90 of upstream module 110 in close proximity to the female connector portion 92 of downstream module 112 as shown, for example, in FIGS. 12a. The male and female connector portions 90, 92 are then mated as shown, for example, in FIGS. 12b. Welder 114 using weldment provided by a weldment source 116 (see FIG. 1) is operated to apply a weldment seal 118 to a junction 120 between the pair of adjacent modules 110, 112 to provide an annular sealed connection to retain modules 110, 112 in sealed fixed relation to one another.

Other types of module connectors are illustrated in FIGS. 13-16. An upstream module 122 includes female connector portion 92 and a downstream module 124 includes a matching male connector portion 90 as shown, for example, in FIG. 13. An upstream module 126 includes male connector portion 90 and a downstream module 128 includes a matching female connector portion 92 as shown, for example, in FIG. 14. An upstream module 130 includes female connector portion 92 and a downstream module 132 includes a matching male connector portion 90 as shown, for example, in FIG. 15. An upstream module 134 includes female connector portion 92 and a downstream module 136 includes matching male connector portion 90 as shown, for example, in FIG. 16.

Metallic catalyzed substrates, ceramic catalyzed substrates, and diesel particulate traps can all be used to define a modular contaminant filter in contaminant-filter inventory 16. As shown, for example, in FIG. 3, a downstream end of a metal sleeve 140 containing a metallic catalyzed substrate 142 can be deformed to provide male connector portion 90 and an opposite upstream end thereof can be formed to provide female connector portion 92. As shown, for example, in FIG. 4, a downstream end of a metal sleeve 144 containing a ceramic catalyzed substrate 146 and intumescent mat mount material 148 wrapped around substrate 146 can be deformed to provide male connector portion 90 and an opposite upstream end thereof can be formed to provide female connector portion 92.

Many suitable techniques can be used to deform an exterior sleeve of a modular exhaust component to provide either a male or female connector portion 90, 92. The end of the sleeve can, for example, be pressed into a sizing ring, sized with segmented fingers, or spun to assume a desired flared shape.

An exhaust processor 150 made at exhaust processor assembly site 10 using the kit disclosed herein is shown in FIG. 11. As illustrated therein, various modules can be arranged in series in end-to-end relation to establish exhaust processor 150 even though the wall thicknesses of the various modules 22, 28, 30, 44, and 36 comprising the processor 150 vary. The exterior sleeves 152 included in modular contaminant filters 28, 30 have a thickness dimension 154 that is greater than a thickness dimension 156 associated with the other modules 22, 44, 36. The substrates 158 included in contaminate filter modules 28, 30 are heavy and need to be supported by thicker exterior sleeves 152. This variation in exterior sleeve wall thickness does not interfere with the interchangeability of the modular exhaust components and enhances the viability of the kit disclosed herein. Thus, it is not necessary to provide a single exterior sleeve that extends along the entire length of the processor, which sleeve is made of thick, heavy gauge steel of a type that would be sufficient to support the substrates contained therein. The cost and mass of the processor would be increased if a single heavy gauge steel exterior sleeve had to be included in the processor.

The exhaust processor assembly kit described in this disclosure provides an apparatus and process for coupling together modular exhaust components to form a combined emissions/silencing exhaust processor. The processor will typically comprise an inlet diffusion chamber, one or more ceramic or metallic catalyzed substrates or diesel particulate traps, and a tuning cartridge comprising a noise filter and perhaps an additional expansion chamber. However, depending on the particular function that the processor is designed to serve, the vehicle application, or its packaging constraints, the processor may have more or fewer exhaust components than shown in FIGS. 5-11 but a minimum of two, and they may or may not include all four types indicated in FIG. 1.

Each modular exhaust component disclosed herein will be independent of the other and self-contained in its own steel housing. The inlet component (and each subsequent component—but not including the final outlet component) will have a step formed on its outlet end, allowing it to slip inside the inlet end of the next component. In this way, components may be stacked one on top of the other or end-to-end and welded together. The order in which components are stacked will depend on the designated function(s) of the processor.

Interchangeable, stackable, modular exhaust components can be arranged easily in a proper sequence to achieve an emissions and silencing goal. Such modular components eliminate the need to use a conventional muffler shell as a structural component to support catalyzed substrates or particulate traps. Therefore, the emissions components and the muffler components may be constructed from different shell materials or thicknesses, allowing optimization of material content within the total processor. This is not possible where catalyzed substrates or particulate traps reside within the overall shell of the device.

The use of interchangeable, stackable, modular exhaust components causes the components to be aligned properly for welding with minimum fixturing. Proper orientation of these concepts is easier to achieve because uniform use of male and female connector portions makes it easier to identify inlet and outlet ends of each component. Since each modular component has its own exterior sleeve, a redundant outer shell in designs where catalyzed substrates might be pushed into a full-length shell is eliminated, thereby reducing cost and mass. Capital equipment requirements are also reduced since machines to push catalyzed substrates into shells are no longer required.

In the modular system disclosed herein, the emissions component and the muffler component can be produced independently of one another. This could lead to greater flexibility in sourcing emissions and muffler components. It may also improve manufacturing flexibility since the muffler producer may now produce only the muffler component while an integrator may assemble the emissions and muffle components together.

Although the invention has been described in detail with reference to certain illustrative embodiments, variations and modifications exist within the scope and spirit of the invention as described and defined in the following claims.

1. An exhaust processor kit having component parts capable of being assembled at an exhaust processor assembly site to provide an exhaust processor assembly configured to be mounted in a vehicle exhaust system to treat combustion product flowing therethrough, the kit comprising the combination of
at least two separate exhaust processor modules adapted to be arranged to lie in series in end-to-end relation to establish a combustion product flow conduit having an upstream inlet and a downstream outlet,
an exhaust inlet module having an inlet end adapted to be coupled to a combustion product source pipe and an outlet end adapted to be coupled to the upstream inlet of the combustion product flow conduit,
an exhaust outlet module having an inlet end coupled to the downstream outlet of the combustion product flow conduit and an outlet end adapted to be coupled to a combustion product discharge pipe, and
a weldment seal adapted to be applied to a junction between each pair of adjacent modules to provide an annular sealed connection at each junction and to retain each pair of adjacent modules in fixed relation to one another.

2. The kit of claim 1, further comprising a contaminant-filter inventory comprising a plurality of modular contaminant filters of varying types and wherein the at least two separate exhaust processor modules includes a first of the types of modular contaminant filters.

3. The kit of claim 2, further comprising a noise-filter inventory comprising a plurality of modular noise filters of varying types and wherein the at least two separate exhaust processor modules further includes a first of the types of modular noise filters.

4. The kit of claim 3, wherein the at least two separate exhaust processor modules further includes a second of the types of modular contaminant filters.

5. The kit of claim 2, wherein the at least two separate exhaust processor modules further includes a second of the types of modular contaminant filters.

6. The kit of claim 5, wherein the first of the types of modular contaminant filters includes means for filtering hydrocarbon material out of a stream of combustion product passing therethrough and the second of the types of modular contaminant filters includes means for filtering oxides of nitrogen out of the stream of combustion product passing therethrough.

7. The kit of claim 2, further comprising an exhaust flow-diffuser inventory comprising a plurality of modular exhaust flow diffusers of varying types and wherein the at least two separate exhaust processor modules further includes a first of the types of modular exhaust flow diffusers.

8. The kit of claim 1, further comprising a noise-filter inventory comprising a plurality of modular noise filters of varying types and wherein the at least two separate exhaust processor modules includes a first of the types of modular noise filters and further comprising an inventory of modular tuning-volume containers, a first of the modular tuning-volume containers having an interior region defining a first volume and a second of the modular tuning-volume containers having an interior region defining a second volume larger than the first volume, and wherein one of the first and second modular tuning-volume containers is included in the at least two separate exhaust processor modules and arranged to place the interior region of said one of the first and second modular tuning-volume containers in acoustic communication with an interior region of the first of the types of modular noise filter to add tuning volume to the first of the types of modular noise filter.

9. The kit of claim 8, further comprising a contaminant-filter inventory comprising a plurality of modular contaminant filters of varying types and wherein the at least two separate exhaust processor modules includes a first of the modular contaminant filters and the one of the first and second modular tuning-volume containers is interposed between the first type of modular contaminant filter and the first type of modular noise filter.

10. An exhaust processor kit having component parts capable of being assembled at an exhaust processor assembly site to provide an exhaust processor assembly configured to be mounted in a vehicle exhaust system to treat combustion product flowing therethrough, the kit comprising the combination of
an exhaust inlet module adapted to be coupled to a combustion product source pipe,
an exhaust outlet module adapted to be coupled to a combustion product discharge pipe,
at least two separate exhaust processor modules adapted to be arranged to lie in series to provide a module conduit having an inlet end adapted to be coupled to the exhaust inlet module to receive combustion product discharged therefrom and an outlet end adapted to be coupled to the exhaust outlet module to cause combustion product that has passed through each of the separate exhaust processor modules to be discharged into the exhaust outlet module, each exhaust processor module including a female processor end adapted to be coupled to one of two adjacent exhaust processor modules and a male processor end adapted to be coupled to another of the two adjacent exhaust processor modules, and a combustion product flow passage extending between the female and male processor ends, and
a weldment seal adapted to be applied to the exhaust inlet, exhaust processor, and exhaust outlet modules at a junction between each pair of coupled adjacent modules to provide an annular sealed connection at each junction and to establish a rigid exhaust processor assembly comprising in series the exhaust inlet module, the at least two separate exhaust processor modules, and the exhaust outlet module.

11. The kit of claim 10, wherein an upstream portion of each of the at least two separate exhaust processor modules is formed to provide the female processor end, a downstream portion of each of the at least two separate exhaust processor modules is formed to provide the male processor end, a downstream portion of the exhaust inlet module is configured to provide a male end adapted to be coupled to the female processor end of the upstream portion of a first in a series of the at least two separate exhaust processor modules, and an upstream portion of the exhaust outlet module is configured to provide a female end adapted to be coupled to the male processor end of the downstream portion of a last in the series of at least two separate exhaust processors.

12. The kit of claim 10, wherein an upstream portion of each of the at least two separate exhaust processor modules is formed to provide the male processor end, a downstream portion of each of the at least two separate exhaust processor modules is formed to provide the female processor end, a downstream portion of the exhaust inlet module is configured to provide a female end adapted to be coupled to the male processor end of the upstream portion of a first in a series of the at least two separate exhaust processor modules, and an upstream portion of the exhaust outlet module is configured to provide a male end adapted to be coupled to the female processor end of the downstream portion of a last in the series of at least two separate exhaust processors.

13. A modular exhaust processor assembly comprising
an exhaust inlet module adapted to be coupled to a combustion product source pipe in a vehicle exhaust system,
an exhaust outlet module adapted to be coupled to a combustion product discharge pipe,
at least two separate exhaust processor modules arranged to lie in series in end-to-end relation to provide a module conduit having an inlet end coupled to the exhaust inlet module to receive combustion product discharged therefrom and an outlet end coupled to the exhaust outlet module to cause combustion product that has passed through each of the separate exhaust processor modules to be discharged from the module conduit into the exhaust outlet module, and
a plurality of sealed connectors, each sealed connector being arranged to establish a sealed connection between ends of pairs of adjacent modules, each sealed connector including a male connector portion located on a first module, a female connector portion located on an adjacent second module and coupled to said male connector portion to define a junction between the first and second modules, and a weldment seal arranged to provide an annular sealed connection at the junction between the first and second modules.

14. The assembly of claim 13, wherein the at least two separate exhaust processor modules include a first modular contaminant filter positioned to lie between the exhaust inlet and outlet modules and a modular noise filter interposed between the first modular contaminant filter and the exhaust outlet module.

15. The assembly of claim 14, wherein the at least two separate exhaust processor modules further include a second modular contaminant filter interposed between the first modular contaminant filter and the modular noise filter.

16. The assembly of claim 13, wherein the at least two separate exhaust processor modules include a modular noise filter positioned to lie between the exhaust inlet and outlet modules and a first modular contaminant filter interposed between the modular noise filter and the exhaust outlet module.

17. The assembly of claim 16, wherein the at least two separate exhaust processor modules further include a modular exhaust flow diffuser interposed between the modular noise filter and the first modular contaminant filter and the modular exhaust flow diffuser is configured to interrupt the flow of combustion product passing therethrough to substantially uniformly distribute the flow of combustion product across an inlet face of a catalyzed substrate included in the first modular contaminant filter to load the catalyzed substrate substantially evenly to enhance combustion product treatment efficiency of the catalyzed substrate included in the first modular contaminant filter.

18. The assembly of claim 16, wherein the at least two separate exhaust processor modules further include a second modular contaminant filter interposed between the first modular contaminant filter of the exhaust outlet module.

19. The assembly of claim 13, wherein the at least two separate exhaust processor modules include a modular noise filter positioned to lie between the exhaust inlet and outlet modules and a modular tuning volume container interposed between the exhaust inlet module and the modular noise filter and coupled to the modular noise filter to add tuning volume to the modular noise filter.

20. The assembly of claim 13, wherein one of the at least two separate exhaust processor modules has an exterior sleeve formed to include the male and female connector portions thereof and sized to have a first thickness and another of the at least two separate exhaust processor modules has an exterior sleeve formed to include the male and female connector portions thereof and sized to have a second thickness different from the first thickness.
